(19) United States
(12) Patent Application Publication
(10) Pub. No.: US 2025/0070500 A1
(43) Pub. Date: Feb. 27, 2025

(54) CABLE ASSEMBLY AND CABLE CONNECTOR WITH IMPROVED STRUCTURAL RELIABILITY

(71) Applicant: Luxshare Precision Industry Company Limited, SHENZHEN (CN)

(72) Inventors: Cheng-Kai LIAO, SHENZHEN (CN); Wei WANG, SHENZHEN (CN); Minquan YU, SHENZHEN (CN); Po-Chang HUANG, SHENZHEN (CN); Ming-Yu HO, SHENZHEN (CN)

(73) Assignee: Luxshare Precision Industry Company Limited, SHENZHEN (CN)

(21) Appl. No.: 18/649,473

(22) Filed: Apr. 29, 2024

(30) Foreign Application Priority Data
Aug. 23, 2023 (CN) 202322283193.3

(51) Int. Cl. H01R 13/514; H01R 12/53; H01R 13/6581; H01R 13/6591

(52) U.S. Cl. CPC H01R 13/514; H01R 12/53; H01R 13/6581; H01R 13/65914

(57) ABSTRACT

A cable assembly, configured to be mounted to a circuit board having a first conductive pad and a second conductive pad, includes a first cable, a second cable and a support member. The first cable includes a first core, a first insulator and a first shielding layer. The second cable includes a second core, a second insulator and a second shielding layer. The first core and the second core are configured to be in contact with the first conductive pad and the second conductive pad. The support member includes a support portion. The support portion is configured to support the first insulator and the second insulator. The connection portion is in contact with the first shielding layer and the second shielding layer. A cable connector having the cable assembly is also disclosed.

### CROSS-REFERENCE TO RELATED APPLICATION

This patent application claims priority of a Chinese Patent Application No. 202322283193.3, filed on Aug. 23, 2023 and titled “CABLE ASSEMBLY AND CABLE CONNECTOR”, the entire content of which is incorporated herein by reference.

### TECHNICAL FIELD

The present disclosure relates to a cable assembly and a cable connector, which belongs to the technical field of connectors.

### BACKGROUND

A cable assembly in the related art generally includes a plurality of cables for being fixed to a circuit board. Each cable includes a core, an insulator circumferentially wrapped around the core, a shielding layer circumferentially wrapped around the insulator, and an insulation skin circumferentially wrapped around the shielding layer.

The cable is generally a coaxial cable, that is, central axes of the core, the insulator, the shielding layer and the insulation skin overlap.

It is understandable to those skilled in the art that the cable needs to be stripped before being fixed to the circuit board. After stripping, a bottom surface of the core, a bottom surface of the insulator, a bottom surface of the shielding layer and a bottom surface of the insulation skin are located in different planes. Generally speaking, the bottom surface of the insulation skin is attached to a surface of the circuit board. The bottom surface of the shielding layer is higher than the surface of the circuit board and has a first gap with the surface of the circuit board. The bottom surface of the insulator is higher than the surface of the circuit board and has a second gap with the surface of the circuit board. The bottom surface of the core is higher than the surface of the circuit board and has a third gap with the surface of the circuit board. The third gap is larger than the second gap. The second gap is larger than the first gap.

In some processes, when the cable is crimped by a crimping device, since there is the second gap between the bottom surface of the insulator and the surface of the circuit board, the insulator in a suspended state is easily crushed and deformed by the crimping device. The deformed insulator will cause relatively large near-end crosstalk when the signal is transmitted in the core, which is not beneficial to the quality of signal transmission.

### SUMMARY

An object of the present disclosure is to provide a cable assembly and a cable connector with high structural reliability.

In order to achieve the above object, the present disclosure adopts the following technical solution: a cable assembly configured to be mounted on a circuit board which includes a first surface, a first conductive pad exposed to the first surface and a second conductive pad exposed to the first surface, including: at least one group of cables including a first cable and a second cable; the first cable including a first core, a first insulator circumferentially wrapped around the first core, and a first shielding layer circumferentially wrapped around the first insulator; the second cable including a second core, a second insulator circumferentially wrapped around the second core, and a second shielding layer circumferentially wrapped around the second insulator; the first core protruding beyond the first insulator in an axial direction so as to be configured to be in contact with the first conductive pad; the second core protruding beyond the second insulator in another axial direction so as to be configured to be in contact with the second conductive pad; a gap being formed between the first insulator and the first surface of the circuit board, and between the second insulator and the first surface of the circuit board; and a support member including a support portion; wherein the support portion fills the gap and is configured to support the first insulator and the second insulator, so as to prevent the first insulator and the second insulator from being crushed.

In order to achieve the above object, the present disclosure adopts the following technical solution: a cable connector, including: a connector joint; and a cable assembly configured to be mounted on a circuit board which includes a first surface, a first conductive pad exposed to the first surface and a second conductive pad exposed to the first surface; the cable assembly including: at least one group of cables including a first cable and a second cable; the first cable including a first core, a first insulator wrapped around the first core, and a first shielding layer wrapped around the first insulator; the second cable including a second core, a second insulator wrapped around the second core, and a second shielding layer wrapped around the second insulator; the first core protruding beyond the first insulator in an axial direction so as to be configured to be in contact with the first conductive pad; the second core protruding beyond the second insulator in another axial direction so as to be configured to be in contact with the second conductive pad; a gap being formed between the first insulator and the first surface of the circuit board, and between the second insulator and the first surface of the circuit board; and a support member including a support portion; wherein the support portion fills the gap and is configured to support the first insulator and the second insulator, so as to prevent the first insulator and the second insulator from being crushed; wherein the connector joint is electrically connected with the circuit board.

Compared with the prior art, the support member of the present disclosure includes the support portion. The support portion fills the gap and is configured to support the first insulator and the second insulator, so as to prevent the first insulator and the second insulator from being crushed. With such arrangement, the cable assembly and the cable connector disclosed in the present disclosure have high structural reliability.

### BRIEF DESCRIPTION OF DRAWINGS

FIG. 1 is a schematic perspective view of a cable connector in accordance with an embodiment of the present disclosure;

FIG. 2 is a partial perspective exploded view of FIG. 1;

FIG. 3 is a partial perspective exploded view of FIG. 2 from another angle;

FIG. 4 is a partially enlarged view of circled part A in FIG. 2;

FIG. 5 is a top view of the cable assembly in accordance with a first embodiment of the present disclosure;

FIG. 6 is a front view of FIG. 5;

FIG. 7 is a partial enlarged view of frame part B in FIG. 6, wherein support members are installed in place;

FIG. 8 is a corresponding partially enlarged view of the frame part B in FIG. 6, wherein the support members are removed;

FIG. 9 is an exploded perspective view of the cable assembly in accordance with the first embodiment of the present disclosure;

FIG. 10 is a schematic perspective view of the support members in a first example in accordance with the first embodiment of the present disclosure;

FIG. 11 is a schematic perspective view of the support members in a second example in accordance with the first embodiment of the present disclosure;

FIG. 12 is a schematic perspective view of the support members in a third example in accordance with the first embodiment of the present disclosure;

FIG. 13 is a schematic perspective view of the cable assembly in accordance with a second embodiment of the present disclosure;

FIG. 14 is a partially enlarged view of circled part C in FIG. 13;

FIG. 15 is a schematic perspective view of the support members in a first example in accordance with the second embodiment of the present disclosure;

FIG. 16 is a schematic perspective view of the support members in a second example in accordance with the second embodiment of the present disclosure;

FIG. 17 is a schematic perspective view of the support members in a third example in accordance with the second embodiment of the present disclosure;

FIG. 18 is a schematic perspective view of the support members in a fourth example in accordance with the second embodiment of the present disclosure;

FIG. 19 is a schematic perspective view of the support members in a fifth example in accordance with the second embodiment of the present disclosure;

FIG. 20 is a right side view of FIG. 13; and

FIG. 21 is a partially enlarged view of frame part D in FIG. 20.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

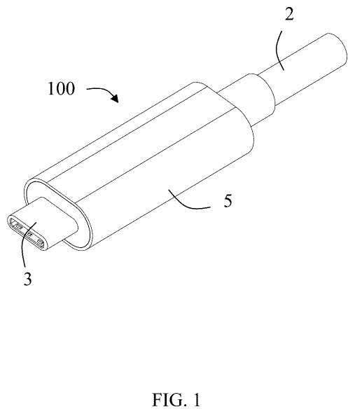

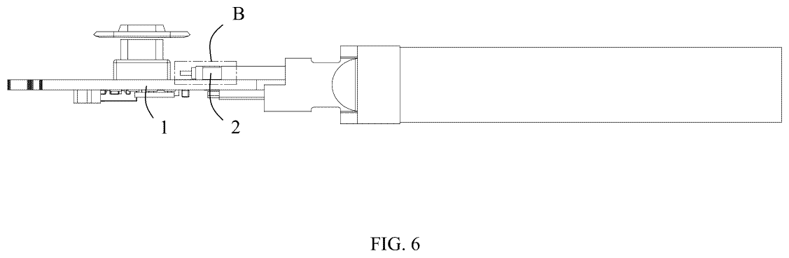

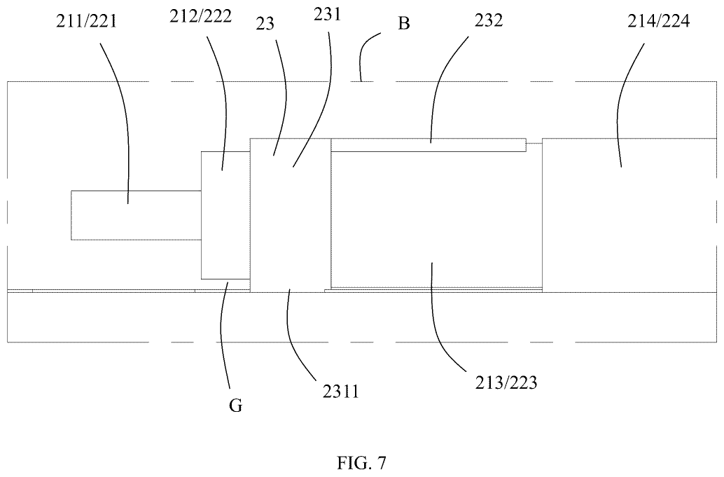

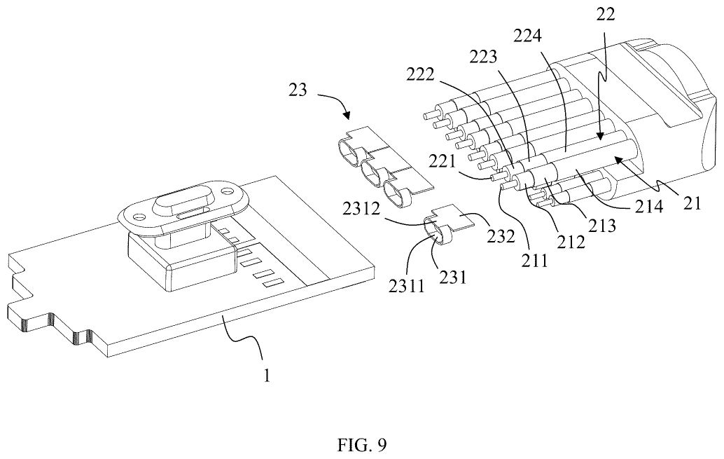

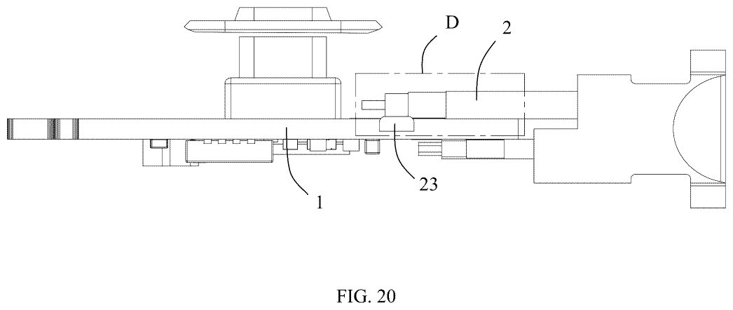

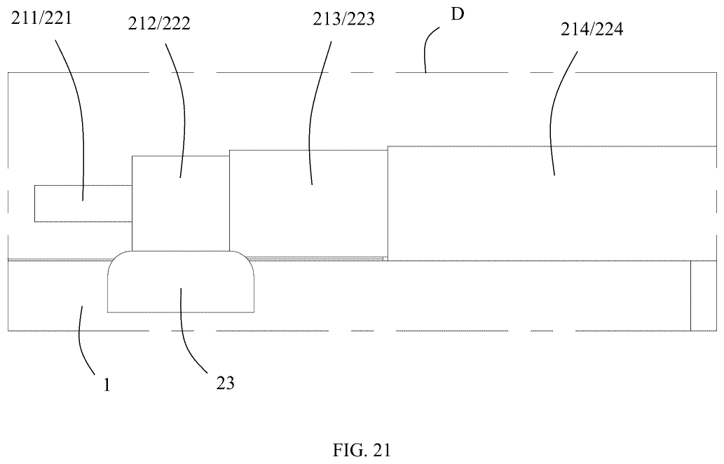

Referring to FIG. 1 to FIG. 21, the present disclosure discloses a cable connector 100 which includes a circuit board 1, a cable assembly 2 connected to the circuit board 1, a connector joint 3 connected to the circuit board 1, a first metal shielding shell 41 partially covering the circuit board 1 from one side, a second metal shielding shell 42 partially covering the circuit board 1 from the other side, and an outer insulating body 5 formed on the first metal shielding shell 41 and the second metal shielding shell 42.

In the illustrated embodiment of the present disclosure, the connector joint 3 is a USB Type-C plug connector. Of course, it is understandable to those skilled in the art that the connector joint 3 can also be other types of connector joints, which will not be repeated in the present disclosure.

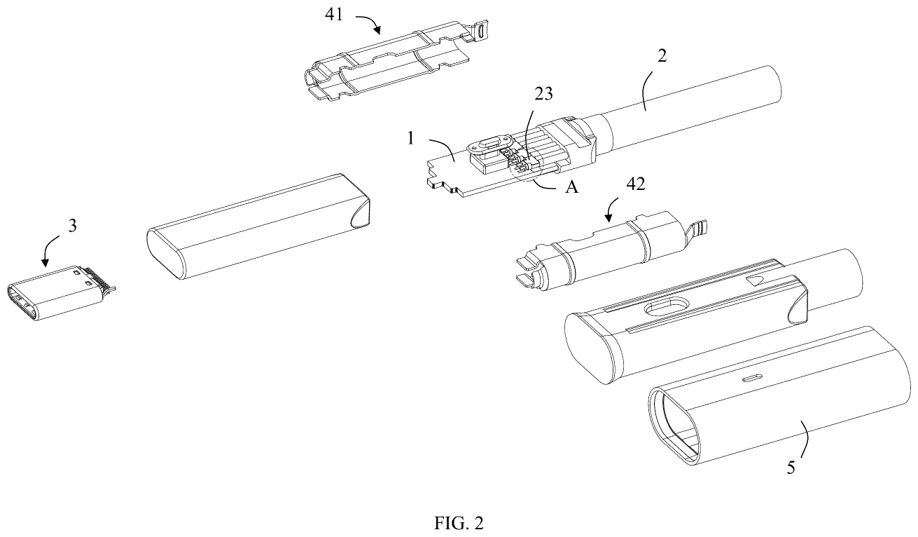

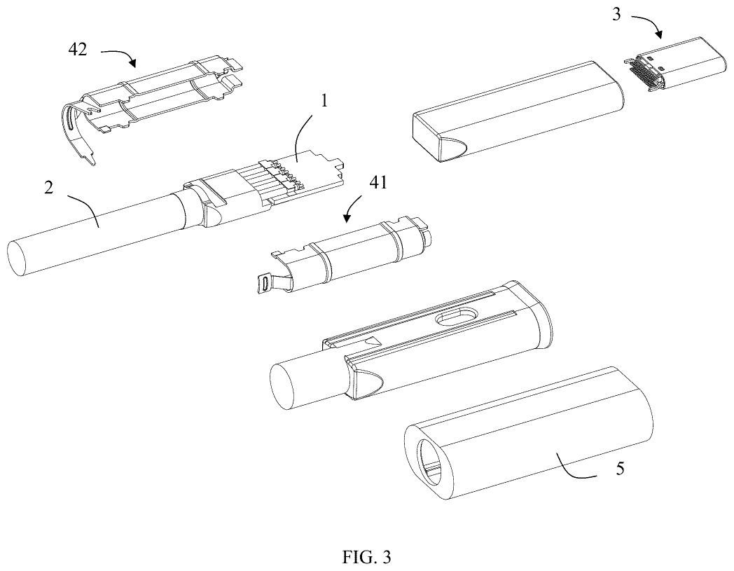

Referring to FIG. 2 and FIG. 3, in the illustrated embodiment of the present disclosure, cross-sections of the first metal shielding shell 41 and the second metal shielding shell 42 are substantially U-shaped. The first metal shielding shell 41 and the second metal shielding shell 42 are enclosed to form a circumferential cavity (not labeled). The circuit board 1 is located in the cavity to reduce the interference of external signals to the circuit board 1.

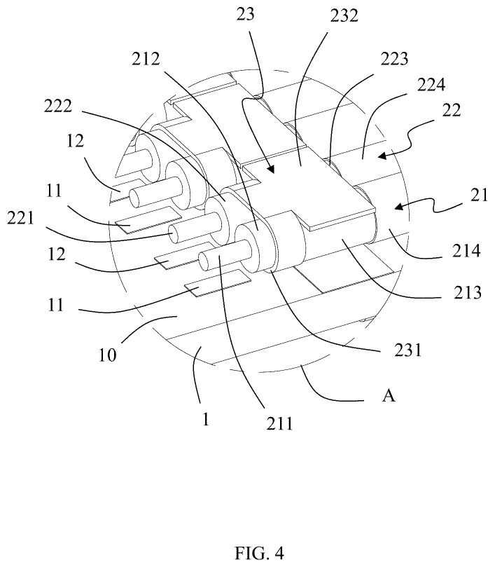

Referring to FIG. 4, the circuit board 1 includes a first surface 10 (for example, an upper surface), a plurality of first conductive pads 11 exposed to the first surface 10, and a plurality of second conductive pads 12 exposed to the first surface 10. In the illustrated embodiment of the present disclosure, the first conductive pad 11 and the second conductive pad 12 which are adjacent to each other form a group of conductive pads. The circuit board 1 includes a plurality of groups of conductive pads which are disposed laterally.

The cable assembly 2 includes a plurality of groups of cables. Each group of cables includes a first cable 21 and a second cable 22. The first cable 21 includes a first core 211, a first insulator 212 circumferentially wrapped around the first core 211, a first shielding layer 213 circumferentially wrapped around the first insulator 212, and a first insulation skin 214 circumferentially wrapped on the first shielding layer 213. The first cable 21 is a coaxial cable, that is, central axes of the first core 211, the first insulator 212, the first shielding layer 213 and the first insulation skin 214 overlap. After stripping, the first shielding layer 213 exposes the first insulation skin 214 in an axial direction; the first insulator 212 exposes the first shielding layer 213 in the axial direction; and the first core 211 exposes the first insulator 212 in the axial direction.

Similarly, the second cable 22 includes a second core 221, a second insulator 222 circumferentially wrapped around the second core 221, a second shielding layer 223 circumferentially wrapped around the second insulator 222, and a second insulation skin 224 circumferentially wrapped on the second shielding layer 223. The second cable 22 is a coaxial cable, that is, central axes of the second core 221, the second insulator 222, the second shielding layer 223 and the second insulation skin 224 overlap. After stripping, the second shielding layer 223 exposes the second insulation skin 224 in another axial direction; the second insulator 222 exposes the second shielding layer 223 in the another axial direction; and the second core 221 exposes the second insulator 222 in the another axial direction.

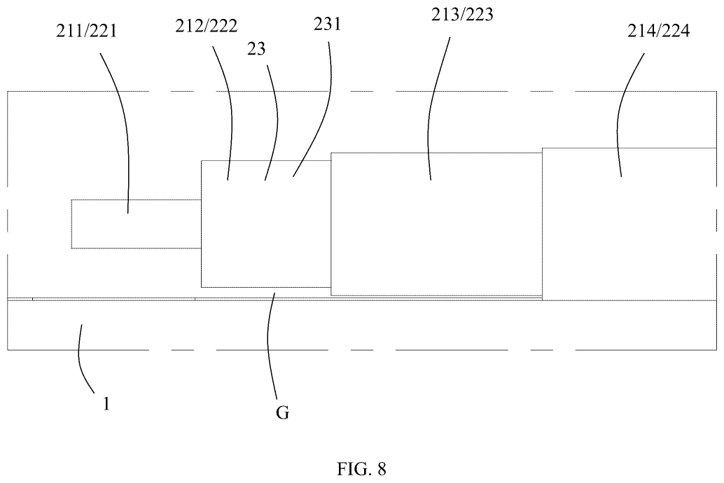

The first core 211 protrudes beyond the first insulator 212 in the axial direction, so as to be configured to contact a corresponding first conductive pad 11. The second core 221 protrudes beyond the second insulator 222 in the another axial direction, so as to be configured to contact a corresponding second conductive pad 12. The first insulation skin 214 and the second insulation skin 224 are attached to a first surface 10 of the circuit board 1. A gap G is formed between the first insulator 212 and the first surface 10 of the circuit board 1, and between the second insulator 222 and the first surface 10 of the circuit board 1 (as shown in FIG. 8).

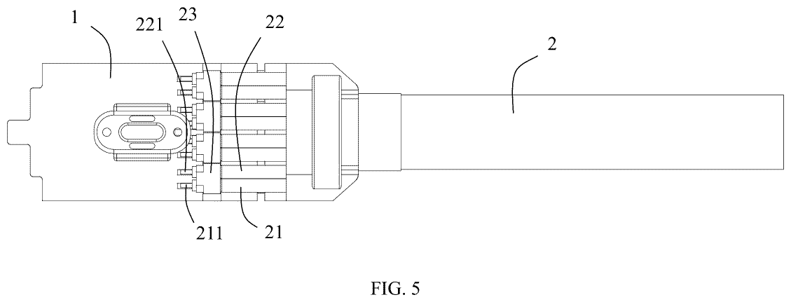

Referring to FIG. 5 to FIG. 10, the support member 23 includes a support portion 231 and a connection portion 232 connected to the support portion 231. The support portion 231 fills the gap G and is configured to support the first insulator 212 and the second insulator 222 in order to prevent the first insulator 212 and the second insulator 222 from being crushed by a crimping device. The connection portion 232 is made of conductive material, including but not limited to metal, conductive plastic and the like. The connection portion 232 is in contact with the first shielding layer 213 and the second shielding layer 223 for achieving a better grounding shielding effect.

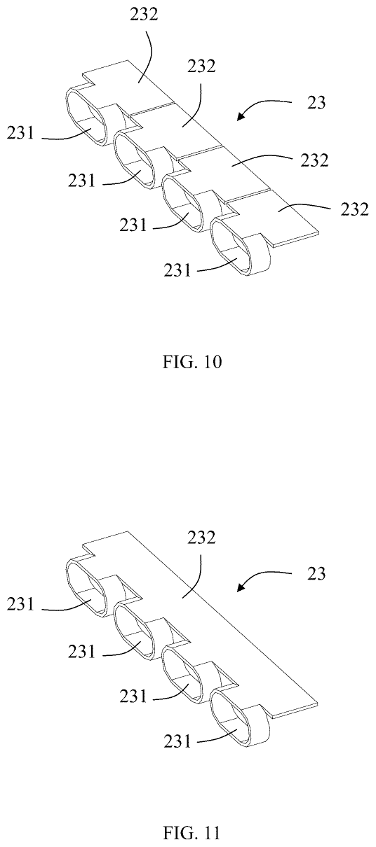

Referring to FIG. 10, in an embodiment of the present disclosure, the support portion 231 is annular-shaped, and is sleeved on the first insulator 212 and the second insulator 222 of each group of cables. The support portion 231 includes a support wall 2311 and an outer wall 2312 opposite to the support wall 2311. The support wall 2311 is filled in the gap G. As shown in the illustrated embodiment of the present disclosure, the outer wall 2312 is integrally formed with the connection portion 232 for ease of manufacture. In the illustrated embodiment of the present disclosure, the outer wall 2312 and the connection portion 232 are located in a same plane.

In the illustrated embodiment of the present disclosure, the cable assembly 2 includes a plurality of groups of cables which are disposed in a transverse direction (for example, a left-right direction). Each group of cables includes the first cable 21 and the second cable 22.

In the illustrated embodiment of the present disclosure, a plurality of support members 23 are provided. The support portion 231 of each support member 23 is sleeved on the first insulator 212 and the second insulator 222 of a corresponding group of cables. The support portions 231 of the plurality of support members 23 are disposed at intervals along the transverse direction. Referring to FIG. 10, in the embodiment illustrated in the present disclosure, each support member 23 is the same for saving costs. In the illustrated embodiment of the present disclosure, the support member 23 is made of metal material.

Referring to FIG. 10, in a first example of the present disclosure, the connection portions 232 of the plurality of support members 23 are disposed at intervals along the transverse direction. That is, along the transverse direction, the connection portions 232 of the plurality of support members 23 are close to each other, but not connected.

Referring to FIG. 11, in a second example of the present disclosure, the connection portions 232 of the plurality of support members 23 are integrated as a whole along the transverse direction. This design is beneficial to improve the ground shielding effect.

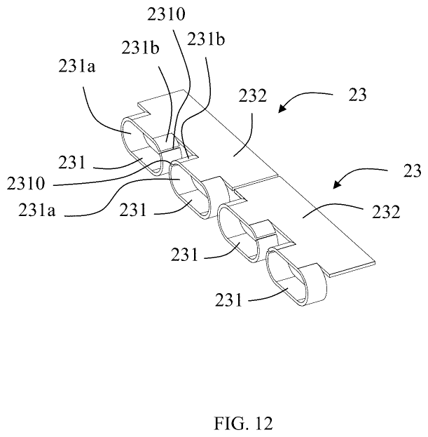

Referring to FIG. 12, in a third example of the present disclosure, each support portion 231 defines a seam 2310. Each support member 23 is provided with one connection portion 232 and two support portions 231. The two support portions 231 are respectively fixed on two adjacent groups of cables. In the two support portions 231, the seam 2310 of one support portion 231 is opposite to the seam 2310 of the other support portion 231, and are respectively located inside the support member 23. During assembly, the support member 23 can be sleeved on the corresponding cables. Alternatively, the support member 23 can be fixed on the corresponding cables by bending or other means. In other words, the support portion 231 disclosed in the third example of FIG. 12 of the present disclosure has more installation methods than the support portion 231 disclosed in the example of FIG. 10 and FIG. 11 of the present disclosure.

As shown in FIG. 12, in the third example of the present disclosure, each support portion 231 includes a long side 231a that is longer in a circumferential direction and a short side 231b that is shorter in the circumferential direction. The seam 2310 is located between the long side 231a and the short side 231b. The short sides 231b of two support portions 231 on the support member 23 are close to each other, and are respectively located inside the support member 23. It is understandable to those skilled in the art that the combined length of the two short sides 231b on the support member 23 corresponds to a certain area of a metal plate. In other words, the two short sides 231b can be formed by stamping from a complete metal plate, which is beneficial to save costs.

In one embodiment of the present disclosure, the support portion 231 and/or the connection portion 232 includes copper so as to improve shielding effect and reduce signal crosstalk.

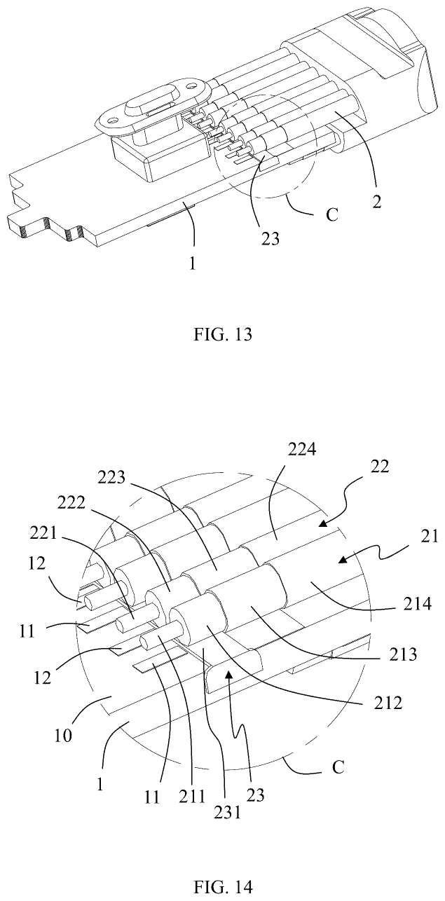

Referring to FIG. 13 to FIG. 21, in another embodiment, the support member 23 is roughly U-shaped, and the support portion 231 is flat. The support portion 231 includes a first end edge 2313 adjacent to conductive pads of the circuit board 1 (such as the first conductive pads 11 and/or the second conductive pads 12), and a second end edge 2314 opposite to the first end edge 2313. The support member 23 further includes a first limiting side wall 233 and a second limiting side wall 234 which are bent from two sides of the support portion 231. The first limiting side wall 233 and the second limiting side wall 234 are located on two sides of the circuit board 1, respectively.

Preferably, the support member 23 further includes an insulating layer 24 located at least between the support portion 231 and the first surface 10 of the circuit board 1. Referring to FIG. 16, in the embodiment illustrated in the present disclosure, the insulating layer 24 is U-shaped which includes an insulating base 241 mated with the support portion 231, a first insulating portion 242 mated with the first limiting side wall 233, and a second insulating portion 243 mated with the second limiting side wall 234. The first insulating portion 242 and the second insulating portion 243 are clamped on two sides of the circuit board 1, respectively.

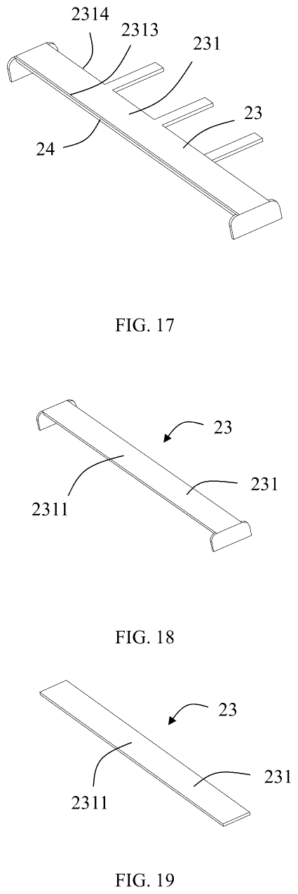

As shown in FIG. 17, the insulating layer 24 is extended at least to cover the first end edge 2313 of the support portion 231, so as to prevent short circuit between the support portion 231 and the conductive pads of the circuit board 1 due to contact.

Referring to FIG. 18 and FIG. 19, the support member 23 itself may be U-shaped or flat.

In some embodiments, the circuit board 1 itself is provided with a ground shielding layer (not shown), and the ground shielding layer is exposed on two sides of the circuit board 1. At this time, the first limiting side wall 233 and the second limiting side wall 234 of the support member 23 may be in contact with the ground shielding layer, so as to further improve the ground shielding effect. In order to save space, recesses may be provided on two sides of the circuit board 1. The ground shielding layer is exposed in the recesses. The first limiting side wall 233 and the second limiting side wall 234 are respectively received in the recesses and are in contact with the ground shielding layer. It is understandable to those skilled in the art that at this time, inner walls of the first limiting side wall 233 and the second limiting side wall 234 are not provided with any insulating elements.

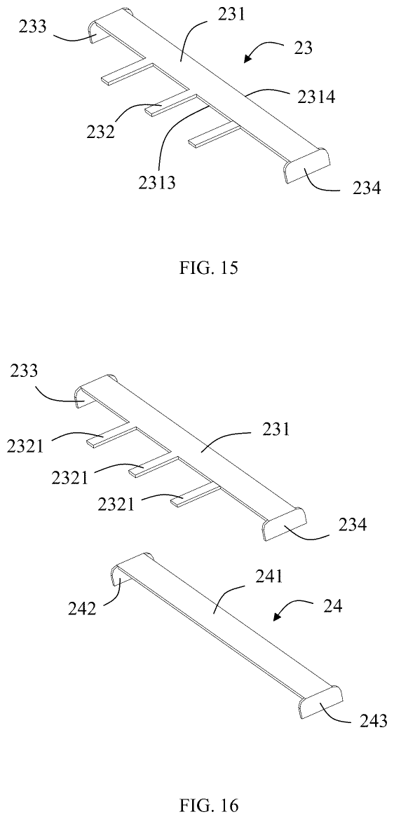

Referring to FIG. 15, in the illustrated embodiment of the present disclosure, the connection portion 232 includes a plurality of connection bars 2321 disposed at intervals along the transverse direction. Each connection bar 2321 is in contact with the first shielding layer 213 and the second shielding layer 223 of a corresponding group of cables, so as to improve the shielding effect.

In the illustrated embodiment of the present disclosure, the plurality of groups of cables disposed in the transverse direction of the cable assembly 2 are fixed on a single surface (for example, the upper surface) of the circuit board 1 by soldering or welding. Such arrangement is beneficial to performing soldering or welding, and improving production efficiency.

Compared with the prior art, the support member 23 of the present disclosure includes the support portion 231 and the connection portion 232 connected to the support portion 231. The support portion 231 fills the gap G and is configured to support the first insulator 212 and the second insulator 222 in order to prevent the first insulator 212 and the second insulator 222 from being crushed by the crimping device. The connection portion 232 is in contact with the first shielding layer 213 and the second shielding layer 223. With such arrangement, the structural reliability of the cable assembly 2 and the cable connector 100 of the present disclosure is relatively high, and the signal transmission quality can be easily ensured.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A cable assembly configured to be mounted on a circuit board which comprises a first surface, a first conductive pad exposed to the first surface and a second conductive pad exposed to the first surface, comprising:
at least one group of cables comprising a first cable and a second cable; the first cable comprising a first core, a first insulator circumferentially wrapped around the first core, and a first shielding layer circumferentially wrapped around the first insulator; the second cable comprising a second core, a second insulator circumferentially wrapped around the second core, and a second shielding layer circumferentially wrapped around the second insulator; the first core protruding beyond the first insulator in an axial direction so as to be configured to be in contact with the first conductive pad; the second core protruding beyond the second insulator in another axial direction so as to be configured to be in contact with the second conductive pad; a gap being formed between the first insulator and the first surface of the circuit board, and between the second insulator and the first surface of the circuit board; and
a support member comprising a support portion; wherein the support portion fills the gap and is configured to support the first insulator and the second insulator, so as to prevent the first insulator and the second insulator from being crushed.

2. The cable assembly according to claim 1, wherein the support member comprises a connection portion connected to the support portion; the connection portion is made of conductive material; the connection portion is in contact with the first shielding layer and the second shielding layer.

3. The cable assembly according to claim 2, wherein the support portion is annular-shaped, and sleeved on the first insulator and the second insulator of each group of cables; the support portion comprises a support wall which is inserted in the gap.

4. The cable assembly according to claim 3, wherein the support portion comprises an outer wall opposite to the support wall; the outer wall is integrally formed with the connection portion.

5. The cable assembly according to claim 4, wherein the outer wall and the connection portion are located in a same plane.

6. The cable assembly according to claim 3, wherein the cable assembly comprises a plurality of groups of cables disposed in a transverse direction; each group of cables comprises the first cable and the second cable;
a plurality of support members are provided; the support portion of each support member is sleeved on the first insulator and the second insulator of a corresponding group of cables.

7. The cable assembly according to claim 6, wherein the support portions of the plurality of support members are disposed at intervals along the transverse direction.

8. The cable assembly according to claim 6, wherein the connection portions of the plurality of support members are disposed at intervals along the transverse direction; or
the connection portions of the plurality of support members are integrated as a whole along the transverse direction.

9. The cable assembly according to claim 2, wherein the support portion and/or the connection portion comprises copper.

10. The cable assembly according to claim 1, wherein the support member further comprises a first limiting side wall and a second limiting side wall which are bent from two sides of the support portion, respectively; the first limiting side wall and the second limiting side wall are located on two sides of the circuit board.

11. The cable assembly according to claim 10, wherein the support member further comprises an insulating layer located at least between the support portion and the first surface of the circuit board.

12. The cable assembly according to claim 11, wherein the insulating layer comprises an insulating base mated with the support portion, a first insulating portion mated with the first limiting side wall, and a second insulating portion mated with the second limiting side wall; the first insulating portion and the second insulating portion are clamped on the two sides of the circuit board.

13. The cable assembly according to claim 9, wherein a plurality of groups of cables are provided and disposed in a transverse direction; each group of cables comprises the first cable and the second cable;
the connection portion comprises a plurality of connection bars disposed at intervals along the transverse direction; each connection bar is in contact with the first shielding layer and the second shielding layer of a corresponding group of cables.

14. The cable assembly according to claim 10, wherein the circuit board comprises a ground shielding layer; the first limiting side wall and/or the second limiting side wall is in contact with the ground shielding layer.

15. The cable assembly according to claim 1, wherein the support portion is annular-shaped, and sleeved on the first insulator and the second insulator of each group of cables; the support portion defines a seam.

16. The cable assembly according to claim 1, wherein the support member further comprises an insulating layer located at least between the support portion and the first surface of the circuit board; the support portion comprises a first end edge adjacent to the first conductive pad and the second conductive pad of the circuit board, and a second end edge opposite to the first end edge; wherein the insulating layer is at least extended to cover the first end edge.

17. The cable assembly according to claim 1, wherein a plurality of groups of cables are provided and disposed in a transverse direction; the plurality of groups of cables are fixed on one side of the circuit board by soldering or welding.

18. A cable connector, comprising:
a connector joint; and
a cable assembly configured to be mounted on a circuit board which comprises a first surface, a first conductive pad exposed to the first surface and a second conductive pad exposed to the first surface; the cable assembly comprising:
at least one group of cables comprising a first cable and a second cable; the first cable comprising a first core, a first insulator wrapped around the first core, and a first shielding layer wrapped around the first insulator; the second cable comprising a second core, a second insulator wrapped around the second core, and a second shielding layer wrapped around the second insulator; the first core protruding beyond the first insulator in an axial direction so as to be configured to be in contact with the first conductive pad; the second core protruding beyond the second insulator in another axial direction so as to be configured to be in contact with the second conductive pad; a gap being formed between the first insulator and the first surface of the circuit board, and between the second insulator and the first surface of the circuit board; and
a support member comprising a support portion; wherein the support portion is inserted in the gap and configured to support the first insulator and the second insulator, so as to prevent the first insulator and the second insulator from being crushed;
wherein the connector joint is electrically connected with the circuit board.

19. The cable connector according to claim 18, further comprising a first metal shielding shell and a second metal shielding shell; the first metal shielding shell and the second metal shielding shell being enclosed to form a circumferentially surrounding cavity in which the circuit board is located.

20. The cable connector according to claim 18, wherein the support portion is annular-shaped, and sleeved on the first insulator and the second insulator of a corresponding group of cables.
